(19) United States
(12) Patent Application Publication
(10) Pub. No.: US 2004/0210499 A1
(43) Pub. Date: Oct. 21, 2004

(54) System and method for shipment management

(76) Inventors: TangHao Chu, Tu-chen (TW); Fucheng Wang, Shenzhen (CN); Zhi Gang He, Shenzhen (CN); Hua Xu, Shenzhen (CN); Andong Lee, Shenzhen (CN); Jinli Ji, Shen zhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/827,973

(22) Filed: Apr. 19, 2004

(30) Foreign Application Priority Data
Apr. 18, 2003 (TW) 92109039

(51) Int. Cl. G06F 17/60

(52) U.S. Cl. 705/34

(57) ABSTRACT

A system for shipment management includes an application server (115), and a database server (117) connected with the application server via a network (107). The application server manages the procedure of shipment, and comprises: a bill generating module (307) for generating a shipment bill; a material collocating module (303) for collocating materials; a shipment identifying module (305) for identifying different shipment modes; and a processing module (308) for management different shipments. The database server stores basic data related to shipment management of the application server. A related method is also disclosed. The method includes the steps of: generating a shipment bill; collocating materials in accordance with the shipment bill; identifying modes of shipment in accordance with a client code; shipping under a first shipment mode, if the client is a factory; and shipping under a second shipment mode, if the client is a third party client.

### BACKGROUND OF THE INVENTION

1. Field of the Invention

The present invention relates to a computer data processing system in a management information system, and especially to a system and method for shipment management employing computers.

2. Background of the Invention

Globalized economic development has brought tremendous business opportunities to numerous enterprises, and has also brought more pressure to bear on manufacturing enterprises. For example, more and more customized products are being ordered by a wider range of customers, and customers are requiring more rigorous quality standards and more demanding delivery deadlines. Further, an enterprise's manufacturing may be conducted in a number of different countries around the world, making management of the enterprise a challenging task. A competitive enterprise needs to adopt new technologies, design new products, reduce manufacturing cycles of products, enhance productivity, and reduce costs. Such enterprise should also strengthen manufacturing management, such as supply of materials, product manufacturing, and merchandise distribution. The enterprise should further cooperate with suppliers, dealers, and customers to make the best of their shared and respective resources. By such means, the enterprise can achieve high customer satisfaction, and maintain keen competitiveness.

For a manufacturing enterprise, storage costs has always been a significant part of overall operating costs. Strengthening inventory management to reduce storage costs is an important way to reduce operating costs and increase profits. Computer systems help to enhance efficiency in the procedures of stocking and shipment in an inventory system. For example, P. R. China patent application No. 01120143.6 entitled “Automatic Management System And Method For Logistics” discloses a system for managing stock and shipment. The system uses a stock processing module, a collecting module, and a shipment processing module to automatically manage the procedures of stocking and shipment. The system can enhance efficiency in the procedures of stocking and shipment for a single client.

However, the system does not address the various needs of different clients. Using the same mode in shipment to different clients increases shipment costs, increases the possibility of shipment “logjams,” and reduces the efficiency of shipment.

### SUMMARY OF THE INVENTION

Accordingly, an objective of the present invention is to provide a system and method for shipment management which uses different modes when shipping to different clients.

Another objective of the present invention is to provide a system and method for shipment management which can enhance shipment efficiency.

In order to achieve the first above-mentioned objective, a system for shipment management in accordance with the present invention comprises an application server, and a database server connected with the application server via a network. The application server manages the procedure of shipment, and further comprises: a bill generating module for generating a shipment bill in accordance with a requirement of a client; a material collocating module for collocating materials in accordance with the shipment bill; a shipment identifying module for identifying different shipment modes in accordance with the shipment bill; and a processing module for management different shipments. The database server stores basic data related to shipment management of the application server.

In order to achieve the second above-mentioned objective, a method for shipment management in accordance with the present invention comprises the steps of: (a) generating a shipment bill; (b) collocating materials in accordance with the shipment bill; (c) identifying modes of shipment in accordance with a client code; (d) shipping under a first shipment mode, if the client is a factory; and (e) shipping under a second shipment mode, if the client is a third party client.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of hardware configuration of a system for shipment management in accordance with a preferred embodiment of the present invention, the system comprising computers, an application server, a databases, and a plurality of workstations;

FIG. 2 is a block diagram of an organizational layout of a warehouse in which materials are stored, in accordance with the present invention;

FIG. 3 is a block diagram of function modules of the application server of FIG. 1;

FIG. 4 is a flow chart of identifying the type of a shipment bill in accordance with a preferred embodiment of the present invention;

FIG. 5 is flow chart of processing under a third party shipment mode in accordance with a preferred embodiment of the present invention; and

FIG. 6 is a flow chart of processing of a factory shipment mode in accordance with a preferred embodiment of the present invention.

### DETAILED DESCRIPTION OF PREFERRED EMBODIMENTS OF THE INVENTION

Reference will now be made to the drawings to describe the present invention in detail.

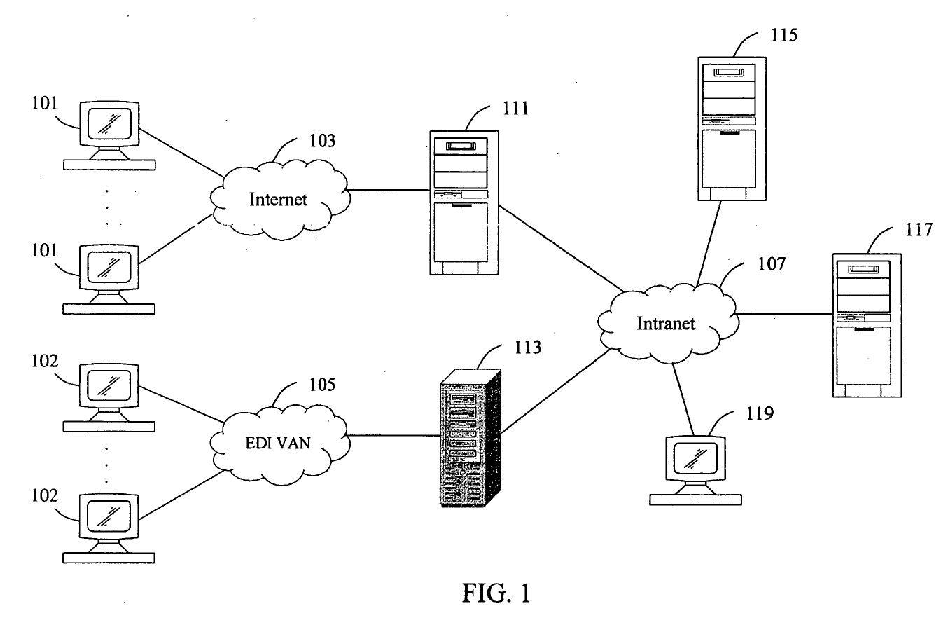

FIG. 1 is a schematic diagram of hardware configuration of a system for shipment management in accordance with the preferred embodiment of the present invention. The system for shipment management comprises a three-layer information system. The three-layer information system comprises a data access layer, a business logic layer, and a presentation layer. The data access layer comprises a database server 117. The business logic layer comprises an application server 115. The presentation layer comprises a plurality of workstations 119, each located in a respective warehouse. For the purposes of conveniently illustrating the preferred embodiment of the present invention, only one workstation 119 is shown and described hereinafter. An intranet 107 interconnects the business logic layer and the data access layer. The intranet 107 can also connect with an MRPII (Manufacture Resource Planning) system, an ERP (Enterprise Resource Planning) system, or another kind of information system.

The database server 117 has a database located therein, which stores all structured data of an enterprise (such as products, clients, and financing) that employs the system for shipment management. The database server 117 is used for managing processing of the stored data. Such processing includes reading, writing, deleting, modifying, and backup. The application server 115 comprises core and mutable enterprise logic (such as rules, execution, and management) of the system for shipment management. The application server 115 comprises a plurality of software modules (described in detail below in relation to FIG. 3), and provides functions for managing shipment. The workstation 119 is located in its respective warehouse. Via the workstation 119, a user can access the application server 115 and manage shipment procedures.

The intranet 107 is also interconnected with a web server 111 and an EDI (Electronic Data Interchange) server 113. The web server 111 connects with a plurality of client computers 101 via the internet 103. The EDI server 113 interchanges EDI data with a plurality of EDI terminals 102 via an EDI VAN (Value Added Network) 105. The EDI data comprise inventory information, shipment information, invoices and so on.

The client computers 101 and the EDI terminals 102 can also connect with an information system. The information system may connect with an MRPII (Manufacture Resource Planning) system, an ERP (Enterprise Resource Planning) system, or another kind of information system. The client computers 101 access the web server 111 via the internet 103 by using a browser such as Internet Explorer by Microsoft, or Navigator by Netscape. The web server 111 sends query requests from the client computers 102 to the application server 115, processes query results, and returns the query results to the client computers 102.

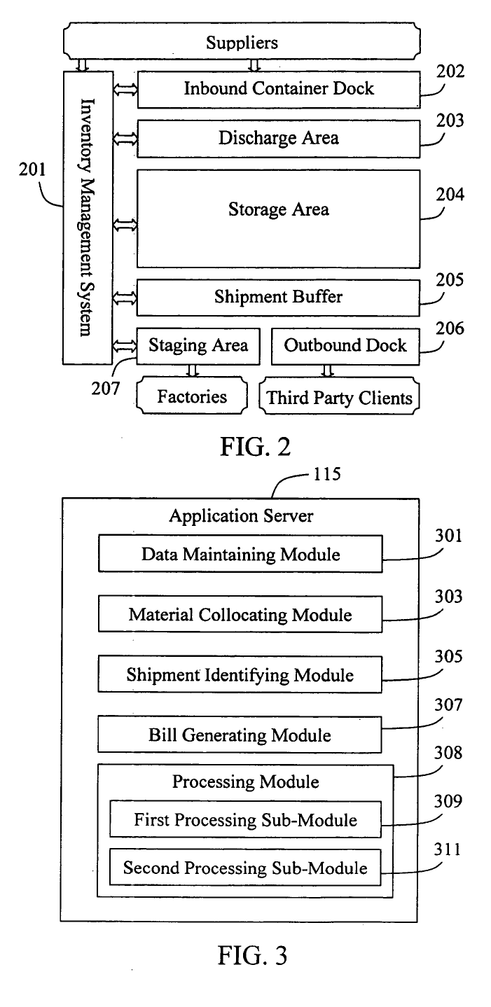

FIG. 2 is a block diagram of an organizational layout of a warehouse in which materials are stored, in accordance with the present invention. Typically, the warehouse is located near the premises of a customer, making it convenient to deliver inventory to the customer. The warehouse comprises six main areas: an inbound container dock 202, a discharge area 203, a storage area 204, a shipment buffer 205, a staging area 207, and an outbound dock 206. The discharge area 203 is used for temporarily storing offloaded inbound inventory. Generally, inventory flows from a supplier to a customer through the six main areas. The storage area 204 is divided into a plurality of areas, and each area has an area code. Each area of the storage area 204 is divided into a plurality of units, and each unit has a unit code. The area codes and the unit codes help to precisely locate materials stored in the warehouse.

An inventory management system 201 manages the processes of receiving, storing, and shipping inventory. The system for shipment management is one part of the inventory management system 201, and is used to manage the process of shipping inventory. In the environment of the present invention, the supplier is the organization that supplies materials, and the supplier owns the materials. The customer is the organization that uses the materials. The customer may be a factory or a third party client. The factories comprise manufacturing shop floors near the warehouse. The third party clients are users of the materials, who are usually located some distance away from the warehouse. Typically, materials must be transported long distances from the warehouse to the third party clients. Once materials leave the warehouse, ownership of the materials switches to the customer.

FIG. 3 is a block diagram of function modules of the application server 115. The application server 115 comprises a data maintaining module 301, a material collocating module 303, a shipment identifying module 305, a bill generating module 307, and a processing module 308.

The data maintaining module 301 is used to maintain basic data of the system stored in the database server 117. Such maintenance includes defining, establishing, adding, modifying, deleting and querying the basic data. The basic data of the system comprise data on warehouses, suppliers, clients, and materials. The warehouse data comprise data on area codes of the storage area 204 of the warehouses, and unit codes of units in each area. The supplier data comprise data on codes of the suppliers, names of the suppliers, EDI codes of the suppliers, EDI names of the suppliers, addresses of the suppliers, types of the suppliers, and so on. The client data comprise data on codes of the clients, names of the clients, EDI codes of the clients, EDI names of the clients, addresses of the clients, types of the clients, and so on. The material data comprise data on codes of suppliers that own materials, codes of clients that are to own the materials, codes of the materials, inbound times of the materials, and forecast outbound times of the materials. The above-mentioned basic data are processed by the inventory management system 201, and form inventory data.

The bill generating module 307 generates shipment bills in accordance with requirements of clients, and comprises data on client codes, material codes, and quantities of materials. The material collocating module 303 collocates materials in accordance with a shipment bill. The procedure of collocating comprises selecting a supplier, and selecting areas and units where corresponding materials are stored. The material collocating module 303 adds the supplier codes, the area codes, and the unit codes to the shipment bill. The shipment identifying module 305 identifies types of the shipment bill in accordance with the client code of the shipment bill, and selects a suitable one of different shipment modes. The shipment modes comprise a factory shipment mode and a third party shipment mode.

The processing module 308 manages the procedure of shipment in different shipment modes, and comprises a first processing sub-module 309 and a second processing sub-module 311. The first processing sub-module 309 manages processing under the third party shipment mode. Under this mode, the procedure comprises transporting the materials, switching ownership of the materials, and generating a passport. The second processing sub-module 311 manages processing under the factory shipment mode. Under this mode, the procedure comprises selecting a shipment bill, checking the shipment bill, transporting the materials, switching ownership of the materials, and generating a passport.

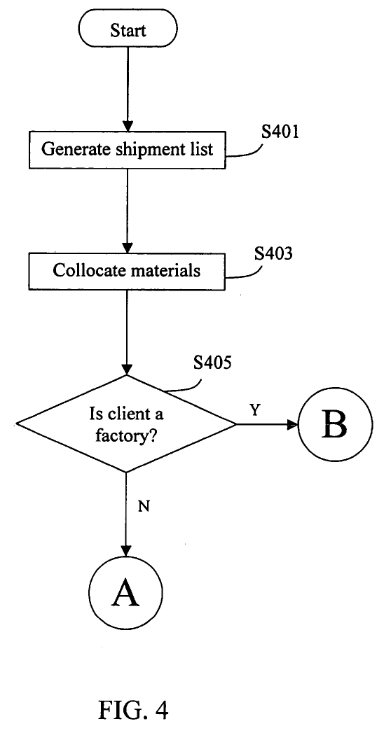

FIG. 4 is a flow chart of identifying the type of a shipment bill, in accordance with the present invention. Firstly, in step S401, the bill generating module 307 generates a shipment bill in accordance with a requirement of a client. The requirement of the client may be a manufacturing order of a factory, or an order form of a third party client or factory. The requirement of the client may be generated by an MRPII or ERP system of the enterprise, or may be input by a user. The shipment bill comprises data on a client code, material codes, and a quantity of materials. In step S403, the material collocating module 303 collocates the materials in accordance with the shipment bill. The material collocating module 303 selects suppliers in accordance with the client code and each material code of the shipment bill, and adds the applicable area codes and unit codes to the shipment bill in accordance with the supplier code, material codes and quantity of materials.

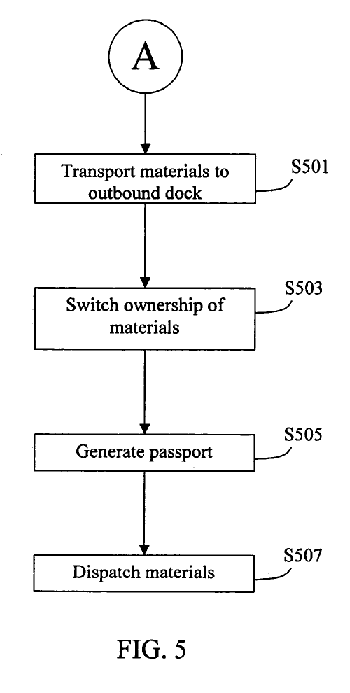

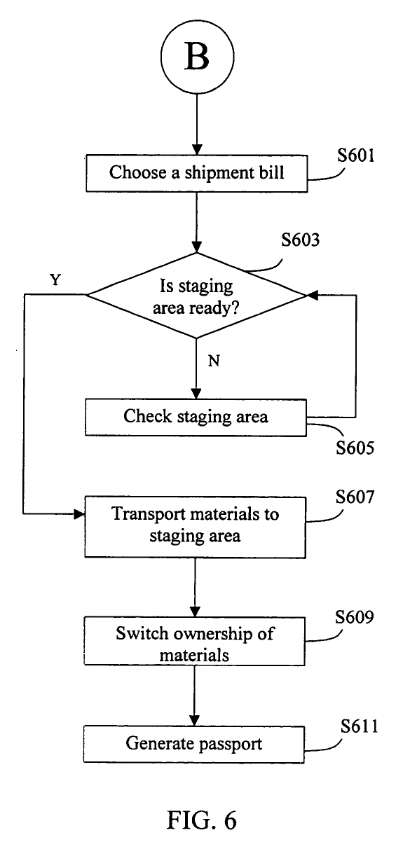

In step S405, the shipment identifying module 307 identifies a mode of shipment in accordance with the client code of the shipment bill, and determines whether the client is a factory. If the client is a factory, the procedure goes to step B (described in detail below in relation to FIG. 6). If the client is not a factory, the procedure goes to step A (described in detail below in relation to FIG. 5).

FIG. 5 is a flow chart of processing under the third party shipment mode, in accordance with the present invention. In step S501, workers at the warehouse transport the materials from the storage area 204 to the outbound dock 206 in accordance with the area codes and unit codes recorded in the shipment bill. The first processing sub-module 309 modifies a depository of the materials in the shipment bill to the outbound dock 206. In the outbound dock 206, the material code and quantity of the materials are input in the inventory management system 201, for subsequent checking of the shipment bill. In step S503, the first processing sub-module 309 switches ownership of the materials input in the inventory management system 201, and generates a shipment form. The process of switching ownership of the materials comprises the steps of: the first processing sub-module 309 sending a receipt confirmation to the supplier via the EDI server 113 and the EDI VAN 105; and the data maintaining module 301 updating data on materials stored in the database server 117. In step S505, the first processing sub-module 309 generates a passport in accordance with the material codes and quantity of materials input in the inventory management system 201. In step S507, the materials in the outbound dock 206 are dispatched to the third party client. The first processing sub-module 309 updates an inventory record in the outbound dock 206 via the data maintaining module 301, and generates a shipment record.

FIG. 6 is a flow chart of processing under the factory shipment mode, in accordance with the present invention. In step S601, the second processing sub-module 311 obtains a collocated shipment bill, and marks the shipment bill with processing. In step S603, the second processing sub-module 311 checks an inventory record of the staging area 207, and determines whether the staging area 207 is ready for loading of the materials. If the inventory record of the staging area 207 is not empty, this means that the staging area 207 is not ready. Accordingly, in step S605, the second processing sub-module 311 periodically checks the inventory record of the staging area 207 until the inventory record is empty.

If and when the staging area 207 is ready, in step S607, the workers at the warehouse transport the materials from the storage area 204 to the staging area 207 in accordance with the area codes and unit codes of the shipment bill. The second processing sub-module 311 generates an inventory record of the staging area 207, and modifies a depository of the materials in the shipment bill to the staging area 207. In the staging area 207, the material code and quantity of the materials are input in the inventory management system 201, for subsequent checking of the shipment bill. In step S609, the second processing sub-module 311 switches ownership of the materials input in the inventory management system 201, and generates a shipment form. The processing of switching ownership of the materials comprises the steps of: the second processing sub-module 311 sending a receipt confirmation to the supplier via the EDI server 113 and the EDI VAN 105; and the data maintaining module 301 updating data on materials stored in the database server 117. In step S611, the second processing sub-module 311 generates a passport in accordance with the material codes and quantity of materials input in the inventory management system 201. The second processing sub-module 311 updates an inventory record in the staging area 207 via the data maintaining module 301, and generates a shipment record once the materials in the staging area 207 have been dispatched to the factory.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for shipment management, the system comprising an application server, and a database server connected with the application server via a network, wherein:
the application server manages the procedure of shipment, and comprises:
a bill generating module for generating a shipment bill in accordance with a requirement of a client;
a material collocating module for collocating materials in accordance with the shipment bill;
a shipment identifying module for identifying different shipment modes in accordance with the shipment bill; and
a processing module for management of different shipments; and
the database server stores basic data related to shipment management of the application server.

2. The system as claimed in claim 1, further comprising a workstation located in a warehouse for accessing the application server.

3. The system as claimed in claim 2, wherein the shipment bill comprises data on client codes, supplier codes, material codes and quantities of the materials.

4. The system as claimed in claim 1, wherein the basic data stored in the database server comprises warehouse data, client data, supplier data and material data.

5. The system as claimed in claim 1, wherein the application server further comprises a data maintaining module for defining, establishing, adding, modifying, deleting and querying the basic data stored in the database server.

6. The system as claimed in claim 1, wherein the shipment modes comprise a factory shipment mode and a third party shipment mode.

7. The system as claimed in claim 6, wherein the processing module further comprises a first processing sub-module and a second processing sub-module, wherein the first processing sub-module manages processing under the third party shipment mode, and the second processing sub-module manages processing under the factory shipment mode.

8. A method for shipment management, the method comprising the steps of:
generating a shipment bill;
collocating materials in accordance with the shipment bill;
identifying modes of shipment in accordance with a client code;
shipping under a first shipment mode, if the client is a factory; and
shipping under a second shipment mode, if the client is a third party client.

9. The method as claimed in claim 8, wherein the step of collocating materials further comprises the step of selecting a supplier in accordance with the client code.

10. The method as claimed in claim 8, wherein the step of collocating materials further comprises the step of collocating the materials with area codes and unit codes of a warehouse.

11. The method as claimed in claim 8, wherein the step of shipping under a first shipment mode comprises the steps of:
selecting a shipment bill;
checking a staging area;
transporting the materials from a storage area to the staging area;
switching ownership of the materials; and
generating a passport.

12. The method as claimed in claim 8, wherein the step of shipping under a second shipment mode comprises the steps of:
transporting the materials from a storage area to an outbound dock;
checking the materials in the outbound dock;
switching ownership of the materials; and
generating a passport.
